(19) United States
(12) Patent Application Publication
(10) Pub. No.: US 2024/0159875 A1
(43) Pub. Date: May 16, 2024

(54) SYSTEMS, METHODS, AND DEVICES FOR COMBINING MULTIPLE OPTICAL COMPONENT ARRAYS

(71) Applicant: Neural Propulsion Systems, Inc., Pleasanton, CA (US)

(72) Inventor: Daniel M. BROWN, Gurley, AL (US)

(73) Assignee: Neural Propulsion Systems, Inc., Pleasanton, CA (US)

(21) Appl. No.: 18/550,770

(22) PCT Filed: Mar. 15, 2022
(86) PCT No.: PCT/US2022/020303

§ 371 Date: Sep. 15, 2023

Related U.S. Application Data
(60) Provisional application No. 63/162,362, filed on Mar. 17, 2021.

(51) Int. Cl. G01S 7/481; G01S 17/89

(52) U.S. Cl. CPC G01S 7/4815; G01S 7/4816; G01S 17/89

(57) ABSTRACT

Disclosed herein are techniques relating to a light detection and ranging (LiDAR) system that includes a first optical array including a first active area, a second optical array including a second active area, wherein the first active area and the second active area are separated by a distance, and at least one optical component configured to laterally-shift a virtual image corresponding to at least one of the first optical array or the second optical array, thereby reducing a gap in a field of view (FOV) of the LiDAR system. The at least one optical component may be reflective, refractive, diffractive, or a combination of reflective, refractive, and/or diffractive. The at least one optical component may include one or more prisms and/or one or more mirrors. The optical arrays can be emitter arrays (e.g., lasers) or detector arrays (e.g., photodiodes). The techniques described herein can be used to combine more than two optical arrays.

### CROSS-REFERENCE TO RELATED APPLICATIONS

This application claims priority to, and hereby incorporates by reference in its entirety, U.S. Provisional Application No. 63/162,362, filed Mar. 17, 2021 and entitled “Systems, Methods, and Devices for Combining Multiple Vertical-Cavity Surface-Emitting Laser (VCSEL) Arrays” (Attorney Docket No. NPS009P).

### BACKGROUND

There is an ongoing demand for three-dimensional (3D) object tracking and object scanning for various applications, one of which is autonomous driving. Light detection and ranging (LiDAR) systems use optical wavelengths that can provide finer resolution than other types of systems (e.g., radar), thereby providing good range, accuracy, and resolution. In general, LiDAR systems illuminate a target area or scene with pulsed laser light and measure how long it takes for reflected pulses to be returned to a receiver.

One aspect common to certain conventional LiDAR systems is that the beams of light emitted by different lasers are very narrow and are emitted in specific, known directions so that pulses emitted by different lasers at or around the same time do not interfere with each other. Each laser has a detector situated in close proximity to detect reflections of the pulses emitted by the laser. Because the detector is presumed only to sense reflections of pulses emitted by its associated laser, the locations of targets that reflect the emitted light can be determined unambiguously. The time between when the laser emitted a light pulse and the detector detected a reflection provides the round-trip time to the target, and the direction in which the emitter and detector are oriented allows the position of the target to be determined with high precision. If no reflection is detected, it is assumed there is no target.

In order to reduce the number of lasers and detectors required to provide sufficient scanning of a scene, some LiDAR systems use a relatively small number of lasers and detectors along with some method of mechanically scanning the environment. For example, a LiDAR system may include transmit and receive optics located on a spinning motor in order to provide a 360-degree horizontal field of view. By rotating in small increments (e.g., 0.1 degrees), these systems can provide high resolution. But LiDAR systems that rely on mechanical scanning are subject to constraints on the receiver and transmitter optics. These constraints can limit the overall size and dimensions of the LiDAR system and the sizes and locations of individual components, as well as the measurement range and signal-to-noise ratio (SNR). Moreover, the moving components are subject to failure and may be undesirable for some applications (e.g., autonomous driving).

Another type of LiDAR system is a flash LiDAR system. Flash LiDAR systems direct pulsed beams of light toward a target object within a field of view, and an array of light detectors receives light reflected from the target object. For each pulsed beam of light directed toward the target object, the light detector array can receive reflected light corresponding to a frame of data. By using one or more frames of data, the range or distance to the target object can be obtained by determining the elapsed time between transmission of the pulsed beam of light by the illumination source and reception of the reflected light at the light detector array. Although flash LiDAR systems avoid moving components, in order to unambiguously detect the angles of reflections, the light detector uses a large number of optical detectors, each corresponding to a certain direction (e.g., elevation and azimuth) to scan a large scene. For some applications, such as autonomous driving, the cost, size, and/or power consumption of such a system may be prohibitive.

A LiDAR system that approaches target identification in a manner that is different from conventional LiDAR systems is disclosed in U.S. Pat. No. 11,047,982, entitled “DISTRIBUTED APERTURE OPTICAL RANGING SYSTEM,” which issued on Jun. 29, 2021 and is hereby incorporated by reference in its entirety for all purposes. As compared to conventional LiDAR systems, both the illuminators (e.g., lasers) and detectors (e.g., photodiodes) of the new system, referred to as multiple-input, multiple-output (MIMO) LiDAR, have wider and overlapping fields of view, thus resulting in the potential for a single illuminator to illuminate multiple targets within its field of view and for a single detector to detect reflections (which may have resulted from emissions from different illuminators) from multiple targets within its field of view. To allow the positions (also referred to as coordinates) of multiple targets within a volume of space to be resolved, the disclosed MIMO LiDAR systems use a plurality of illuminators and/or detectors, situated so that they are non-collinear (meaning that they are not all situated on a single straight line). To allow the MIMO LiDAR system to distinguish between reflections of different illuminators' emitted optical signals, illuminators that emit signals within a volume of space at the same time can use pulse sequences having specific properties (e.g., the pulse sequences are substantially white and have low cross-correlation with the pulse sequences used by other illuminators emitting in the same field of view at the same time).

The system described in U.S. Patent Publication No. US 2021/0041562 has no moving mechanical parts and may use multiple lenses to spread light 360 degrees in the horizontal direction and several tens of degrees in the vertical direction.

### SUMMARY

This summary represents non-limiting embodiments of the disclosure.

In some aspects, the techniques described herein relate to a light detection and ranging (LiDAR) system, including: a first optical array including a first active area; a second optical array including a second active area, wherein the first active area and the second active area are separated by a distance; and at least one optical component configured to laterally-shift a virtual image corresponding to at least one of the first optical array or the second optical array, thereby reducing a gap in a field of view of the LiDAR system.

In some aspects, the techniques described herein relate to a LiDAR system, wherein the first optical array is situated in a first die, and the second optical array is situated in a second die, and wherein the first die is in contact with the second die.

In some aspects, the techniques described herein relate to a LiDAR system, further including a imaging lens, and wherein the at least one optical component is situated between the first and second optical arrays and the imaging lens.

In some aspects, the techniques described herein relate to a LiDAR system, wherein the first optical array includes a first plurality of emitters, and the second optical array includes a second plurality of emitters.

In some aspects, the techniques described herein relate to a LiDAR system, wherein the first plurality of emitters and the second plurality of emitters include a plurality of lasers.

In some aspects, the techniques described herein relate to a LiDAR system, wherein at least one of the lasers includes vertical cavity surface emitting laser (VCSEL).

In some aspects, the techniques described herein relate to a LiDAR system, wherein the first optical array includes a first plurality of detectors, and the second optical array includes a second plurality of detectors.

In some aspects, the techniques described herein relate to a LiDAR system, wherein the first plurality of detectors and the second plurality of detectors include a plurality of photodiodes.

In some aspects, the techniques described herein relate to a LiDAR system, wherein at least one of the photodiodes includes an avalanche photodiode (APD).

In some aspects, the techniques described herein relate to a LiDAR system, wherein the at least one optical component includes at least one of a prism or a mirror.

In some aspects, the techniques described herein relate to a LiDAR system, wherein the at least one optical component includes a negative rooftop glass prism situated over the first optical array and the second optical array.

In some aspects, the techniques described herein relate to a LiDAR system, wherein the at least one optical component includes a diffractive surface.

In some aspects, the techniques described herein relate to a LiDAR system, wherein the at least one optical component includes first and second mirrors.

In some aspects, the techniques described herein relate to a LiDAR system, wherein the first and second mirrors are 45-degree mirrors situated between the first optical array and the second optical array, and wherein the first optical array and the second optical array are situated in different planes.

In some aspects, the techniques described herein relate to a LiDAR system, wherein the first active area faces the second active area.

In some aspects, the techniques described herein relate to a LiDAR system, wherein the at least one optical component includes: first and second mirrors in a 45-degree configuration; and first and second prisms situated between the first and second mirrors.

In some aspects, the techniques described herein relate to a LiDAR system, further including: a third optical array including a third active area; and a fourth optical array including a fourth active area, and wherein: the first optical array is situated on a first printed circuit board (PCB), the second optical array is situated on a second PCB, the second PCB being substantially perpendicular to the first PCB, the third optical array is situated on a third PCB, the third PCB being substantially parallel to the first PCB and substantially perpendicular to the second PCB, the fourth optical array is situated on a fourth PCB, the fourth PCB being substantially parallel to the second PCB and substantially perpendicular to the first PCB and to the third PCB, and the at least one optical component includes a first prism situated over the first active area, a second prism situated over the second active area, a third prism situated over the third active area, and a fourth prism situated over the fourth active area.

In some aspects, the techniques described herein relate to a LiDAR system, wherein the first prism, the second prism, the third prism, and the fourth prism are in contact.

In some aspects, the techniques described herein relate to a LiDAR system, wherein the first active area faces the third active area, and the second active area faces the fourth active area.

In some aspects, the techniques described herein relate to a LiDAR system, wherein the first optical array includes a first plurality of emitters, the second optical array includes a second plurality of emitters, the third optical array includes a third plurality of emitters, and the fourth optical array includes a fourth plurality of emitters.

In some aspects, the techniques described herein relate to a LiDAR system, wherein the first plurality of emitters, the second plurality of emitters, the third plurality of emitters, and the fourth plurality of emitters include a plurality of lasers.

In some aspects, the techniques described herein relate to a LiDAR system, wherein at least one of the lasers includes vertical cavity surface emitting laser (VCSEL).

In some aspects, the techniques described herein relate to a LiDAR system, wherein the first optical array includes a first plurality of detectors, the second optical array includes a second plurality of detectors, the third optical array includes a third plurality of detectors, and the fourth optical array includes a fourth plurality of detectors.

In some aspects, the techniques described herein relate to a LiDAR system, wherein the first plurality of detectors, the second plurality of detectors, the third plurality of detectors, and the fourth plurality of detectors include a plurality of photodiodes.

In some aspects, the techniques described herein relate to a LiDAR system, wherein at least one of the photodiodes includes an avalanche photodiode (APD).

### BRIEF DESCRIPTION OF THE DRAWINGS

Objects, features, and advantages of the disclosure will be readily apparent from the following description of certain embodiments taken in conjunction with the accompanying drawings in which:

FIG. 1A is an example of an optical array that can be used in accordance with some embodiments.

FIG. 1B is a far-field image that is obtained without use of the techniques described herein.

FIG. 2 illustrates an example configuration with two optical arrays and at least one optical component in accordance with some embodiments.

FIG. 3 is a far-field image illustrating the benefit of the example embodiments shown in FIG. 2.

FIG. 4 illustrates an example configuration with two optical arrays and two mirrors in accordance with some embodiments.

FIG. 5 is a far-field image illustrating the benefit of the example embodiment shown in FIG. 4.

FIG. 6 illustrates an example configuration with two optical arrays, two prisms, and two mirrors in accordance with some embodiments.

FIG. 7 is a far-field image illustrating the benefit of the example embodiment shown in FIG. 6.

FIG. 8 is a far-field image illustrating the benefit of a modification of the example embodiment shown in FIG. 6.

FIG. 9 is an end-on view of an example system in accordance with some embodiments.

FIG. 10 illustrates certain components of an example LiDAR system in accordance with some embodiments.

To facilitate understanding, identical reference numerals have been used, where possible, to designate identical elements that are common to the figures. It is contemplated that elements disclosed in one embodiment may be beneficially utilized in other embodiments without specific recitation. Moreover, the description of an element in the context of one drawing is applicable to other drawings illustrating that element.

### DETAILED DESCRIPTION

LiDAR systems can use one or more large, addressable arrays of individual optical components. These individual optical components can include emitters (e.g., lasers) and/or detectors (e.g., photodiodes).

For example, a LiDAR system may use an array of vertical-cavity surface-emitting lasers (VCSELs) as the emitters. A VCSEL is a type of semiconductor-based laser diode that emits an optical beam vertically from the top surface of the chip, in contrast to edge-emitting semiconductor lasers, which emit light from the side. Compared to edge-emitting lasers, VCSELs have a narrower wavelength bandwidth, allowing more effective filtering at the receiver, which can result in a higher SNR. VCSELs also emit a cylindrical beam, which can simplify integration into a system. VCSELs are reliable and offer consistent lasing wavelength under a wide variety of temperatures (e.g., up to, for example, 150° C.). VCSELs may be an attractive choice as emitters for a LiDAR system.

Emitter arrays, such as VCSEL arrays, may have practical size limitations due the high currents used to drive them. Electronics constraints and heat dissipation constraints may result in multiple emitter arrays being placed on multiple printed circuit boards (PCBs) in order to provide a LiDAR system with the desired characteristics (e.g., FOV, accuracy, etc.). It would be preferable to have a larger emitter array than is practically allowed using conventional techniques in order to efficiently perform the optical imaging task.

To detect reflections of the light emitted by the emitters, a LiDAR system may use, for example, an array of avalanche photodiodes (APDs). APDs operate under a high reverse-bias condition, which results in avalanche multiplication of the holes and electrons created by photon impact. As a photon enters the depletion region of the photodiode and creates an electron-hole pair, the created charge carriers are pulled away from each other by the electric field. Their velocity increases, and when they collide with the lattice, they create additional electron-hole pairs, which are then pulled away from each other, collide with the lattice, and create yet more electron-hole pairs, etc. The avalanche process increases the gain of the diode, which provides a higher sensitivity level than an ordinary diode. It is desirable in LiDAR systems to use a large number of detectors (pixels) to improve three-dimensional (3D) image resolution.

As for emitter arrays, in practice it may be difficult or impossible to provide a desired size of detector arrays. For example, some types of sensitive and fast detectors used in LiDAR systems (e.g., APDs) cannot be packed into dense arrays as they can be for other applications (e.g., typical silicon camera arrays used in cell phones and digital cameras). For LiDAR use, the wires from each pixel in an APD array are short so that signals go immediately to an on-chip amplifier placed around the periphery of the array. Because of these limitations, the detector array is limited to only a few columns or rows in order to have a reasonable fill factor and avoid having to provide connector wires between pixels and creating dead space.

For some applications, it is desirable for the LiDAR system to cover a large field of view (FOV). For example, for autonomous driving applications, where safety is paramount, it is desirable for the LiDAR system to be able to accurately detect the presence and positions of targets close to, far from, and in a variety of directions around the vehicle.

To cover a large FOV, one or more imaging lenses may be used with emitter arrays and/or detector arrays. The imaging lens produces an image of the detector or emitter at a distant point in the FOV or at infinity (collimated position). One problem, however, is the number of imaging lenses that might be needed to cover the desired FOV. Even using the largest available optical component arrays, the number of imaging lenses that may be needed to cover a large FOV may result in a complete system that is bulky and expensive.

Therefore, there is a need for improvements.

Disclosed herein are systems, devices, and methods for optically combining arrays of emitters and/or detectors. The disclosed techniques can be used to mitigate the effects at least some of the practical limitations of detector arrays and emitter arrays used for LiDAR systems. The techniques disclosed herein can be used to optically combine a plurality of smaller arrays into an effectively larger array. It will be appreciated that light is reversible, and the imaging task can be from an emitter or to a detector. The imaging task simply transforms one image plane (either at detector or object) to another image plane (either at object or detector). For example, emissions from a plurality of discrete emitter arrays can be optically combined so that they provide more complete illumination of a scene, with smaller or no gaps. Conversely, in the other direction, the techniques disclosed herein can be used to optically split a single image of a scene into smaller sub-images that are directed to separate, discrete detector arrays. In some embodiments, multiple physical arrays (emitters and/or detectors) can be situated on multiple printed circuit boards and optically combined so that they appear to be a single virtual array.

Using the techniques described herein, the effective size of an optical component array can be increased, thereby allowing the array to cover a larger FOV and/or increase imaging resolution.

Furthermore, the number of imaging lenses can be reduced by at least half by optically combining multiple physical optical component arrays so that they appear to be a larger monolithic single array with no significant gaps between the active areas. As few as two physical arrays can be combined, but the techniques can also be used to combine a larger number of optical component arrays (e.g., 3, 4, etc.).

Although the techniques described herein may be particularly useful for LiDAR applications (e.g., 3D LiDAR), and some of the examples are in the context of LiDAR systems, it is to be appreciated that the disclosed techniques can also be used in other applications. Generally speaking, the disclosures herein may be applied in any application in which it is desirable or necessary to use multiple, discrete arrays of emitters and/or detectors but to have them function as (or appear to be) a larger, combined and contiguous array.

In the examples below, the arrays are assumed to be emitter arrays, such as VCSEL arrays. It is to be understood that the disclosures are not limited to VCSEL arrays. As explained above, the techniques can be used generally to combine arrays of emitters and/or detectors.

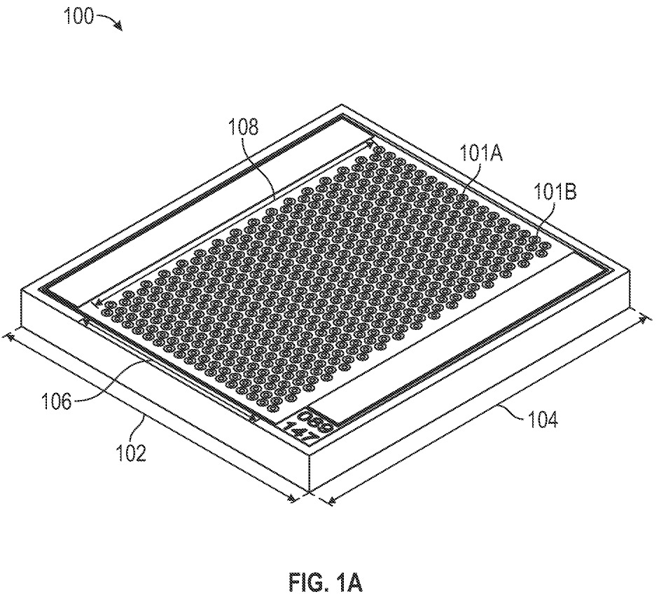

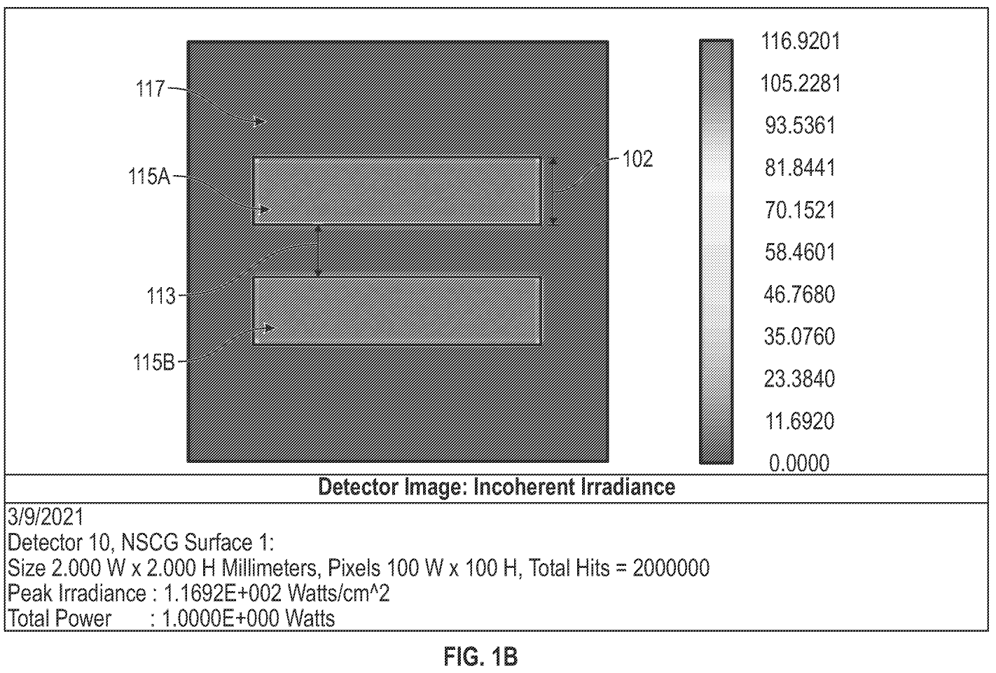

FIG. 1A is an example of an array 100 that can be used in accordance with some embodiments. The array 100 may be, for example, an emitter array (e.g., with multiple VCSELs, lasers, etc.) or a detector array (e.g., with multiple APDs, photodiodes, etc.). As shown in FIG. 1A, the array 100 has a width 102 and a length 104, and it includes a plurality of optical components 101. The example array 100 shown in FIG. 1A includes many individual optical components 101, but to avoid obscuring the drawing, FIG. 1A labels only the optical component 101A and the optical component 101B. Together, the individual optical components 101 form an active array area that has a width 106 and a length 108.

A specific example of an array 100 that may be used in connection with the embodiments disclosed herein (e.g., in systems such as the one described in U.S. Patent Publication No. US 2021/0041562) is the Lumentum VCSEL array having the part number 22101077, which is an emitter array with an active emitter area with a width 106 of 0.358 mm and a length 108 of 1.547 mm and is mounted on a non-emitting ceramic die having a width 102 of 0.649 mm and a length 104 of 1.66 mm. The portion of the width 102 of the die beyond the width 106 of the active area is used for wire bonding emitters to electronic terminals and components.

The dimensions and characteristics of the above-described Lumentum VCSEL array are used as an example in this disclosure, but it is to be appreciated that the techniques disclosed herein can be used with other arrays 100 of optical components 101. For example, as explained above, different types of arrays (emitter or detector) can be optically combined. Similarly, other types of emitter arrays (not necessarily VCSEL arrays, not necessarily from Lumentum) can be used. In the case that the array 100 is a VCSEL array, its characteristics may be different (e.g., power, wavelength, size, etc.) from those of the example Lumentum VCSEL array having the part number 22101077. As a specific example, the Lumentum VCSEL array having the part number 22101080 is similar to the example array 100 described above, but it uses a different wavelength. The Lumentum VCSEL array having the part number 22101080 array would also be suitable.

As one can see from FIG. 1A, if two instances of the array 100 are situated side-by-side and touching, there will be a non-active gap (which may also be referred to as a dead space) between the two active areas of the two arrays 100. In other words, the active areas of the two arrays 100 situated in contact with each other will have a distance between them. For example, in the case of the example Lumentum VCSEL array, the distance, and the dead space, is approximately 0.291 mm.

For some applications, this distance between the active areas of adjacent arrays of the same system (e.g., a LiDAR system) is unacceptable. For example, when the array 100 is an emitter array (e.g., the Lumentum VCSEL array), there is a non-illuminated or non-detected gap in the FOV projected into the far field. What is needed is a way to optically remove this gap in the far-field image so that the two active emitter areas appear to be a single, contiguous active emitter area. For example, it would be desirable for two of the example Lumentum VCSEL arrays to appear to have a single uniform active emitter area with dimensions of 0.716 mm (width 106) by 1.547 mm (length 108). Likewise, when the arrays 100 are detector arrays, it would be desirable to optically remove the gap in the detected FOV due to the distance between the active areas of adjacent arrays 100.

In accordance with some embodiments, the virtual images of N separate arrays 100 are optically combined such that the N separate arrays 100 appear to a imaging lens to be a single monolithic array with an active area that is N times as large as that of a single array 100, with no significant apparent distances between the active areas of the constituent arrays 100. In other words, the physical distances between the active areas of the constituent arrays 100 are optically removed so that the combination of multiple arrays 100 appears to be one larger array with a contiguous active area (e.g., of emitters and/or detectors).

As described further below, there are several ways multiple arrays 100 can be optically combined to remove the dead spaces between their active areas. For example, some embodiments use a purely refractive approach using optical prisms or a negative rooftop (or roof) prism. (It is to be understood that in the art, the term “rooftop” refers to the shape of the prism being similar to a simple roof with a ridge line or peak at the intersection of the two sloping halves of the roof. The sides of the prism may meet at a 90 degree angle or at some other angle. A negative rooftop prism takes the roof and turns it upside down.) Other prisms (e.g., other than rooftop prisms) and/or optical components are also suitable. Some embodiments use a purely diffractive approach using a diffractive optical element. Some embodiments use a purely reflective approach using 45-degree mirrors. Some embodiments use a hybrid refractive-reflective approach that combines both refraction and reflection. Some embodiments combine refractive, diffractive, reflective, and/or hybrid refractive-reflective approaches. Each of these embodiments uses micro-optical elements to effectively remove (or at least reduce) the actual physical gap between the active areas. As a result, a imaging lens can be presented a virtual image of at least one array 100 that is laterally shifted toward a neighboring array 100 so that the gap is not seen by the imaging lens.

To illustrate the problem addressed by the disclosed techniques, FIG. 1B is a far-field image that is obtained without use of the techniques described herein. FIG. 1B shows the result of a simulation (using optical design software) of two example arrays 100 of optical components, two VCSEL arrays situated side by side, mounted as close as possible to each other (e.g., in contact with each other). FIG. 1B shows what the imaging lens sees and projects to the far field. As shown in FIG. 1B, the far field image is simply a replica of the VCSEL arrays in their actual positions. The region 115A and the region 115B represent illuminated regions in the FOV, and the region 117, which is outside of the illuminated region 115A and illuminated region 115B, represents non-illuminated areas. The large gap 113 between the region 115A and region 115B is almost as large as the width 102 of each of the VCSEL arrays. For many applications, this large gap 113 is problematic. For LiDAR applications, for example, the large gap 113 is unacceptable because it means the LiDAR device would not be able to detect targets in the large gap 113.

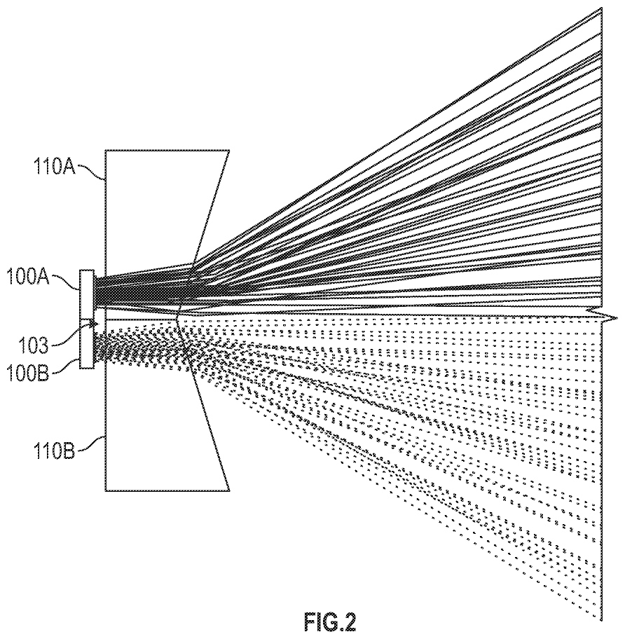

FIG. 2 illustrates an example configuration with two optical arrays and at least one optical component in accordance with some embodiments. FIG. 2 shows an example solution to the problem of FIG. 1B. FIG. 2 shows results of a simulation (using optical design software) of two exemplary arrays 100 of optical components, namely a VCSEL array 100A and a VCSEL array 100B. As shown, the VCSEL array 100A and VCSEL array 100B are situated side by side, mounted as close as possible to each other (e.g., in contact with each other). In the simulation result of FIG. 2, the long dimension of each of VCSEL array 100A and VCSEL array 100B is into the paper. Each of the VCSEL array 100A and VCSEL array 100B may be, for example, a Lumentum VCSEL array with 400 W peak power and a wavelength of 905 nm (part number 22101077). It is to be appreciated that other arrays 100 may be used (e.g., emitters and/or detectors). The use of this particular VCSEL array as an example for the VCSEL array 100A and the VCSEL array 100B is not intended to be limiting. As can be seen in FIG. 2, there is a gap 103 between the active areas of the VCSEL array 100A and the VCSEL array 100B, resulting from the physical limitations described above in the context of FIG. 1A.

The embodiment illustrated in FIG. 2 also includes a prism 110A situated over (or in front of) the VCSEL array 100A and a prism 110B situated over (or in front of) the VCSEL array 100B. Each of the prism 110A and prism 110B may be, for example, a portion of a negative rooftop prism. In other words, the prism 110A and prism 110B may be included in a single prism (e.g., a rooftop prism), which may be a convenient implementation choice. In the embodiment of FIG. 2, the prism 110A and the prism 110B have no optical power, only tilt. Thus, the prism 110A laterally translates the image of the VCSEL array 100A and the prism 110B laterally translates the image of the VCSEL array 100B. Both images are translated without distortion. As can be seen in FIG. 2, rays from the VCSEL array 100A are bent upward, making the VCSEL array 100A appear to be moved downward. Conversely, rays from the VCSEL array 100B are bent downward, making the VCSEL array 100B appear to be moved upward. As a result, the imaging lens (not shown in FIG. 2) sees virtual images of the VCSEL array 100A and the VCSEL array 100B without the gap 103 between them (or at least with the gap 103 reduced).

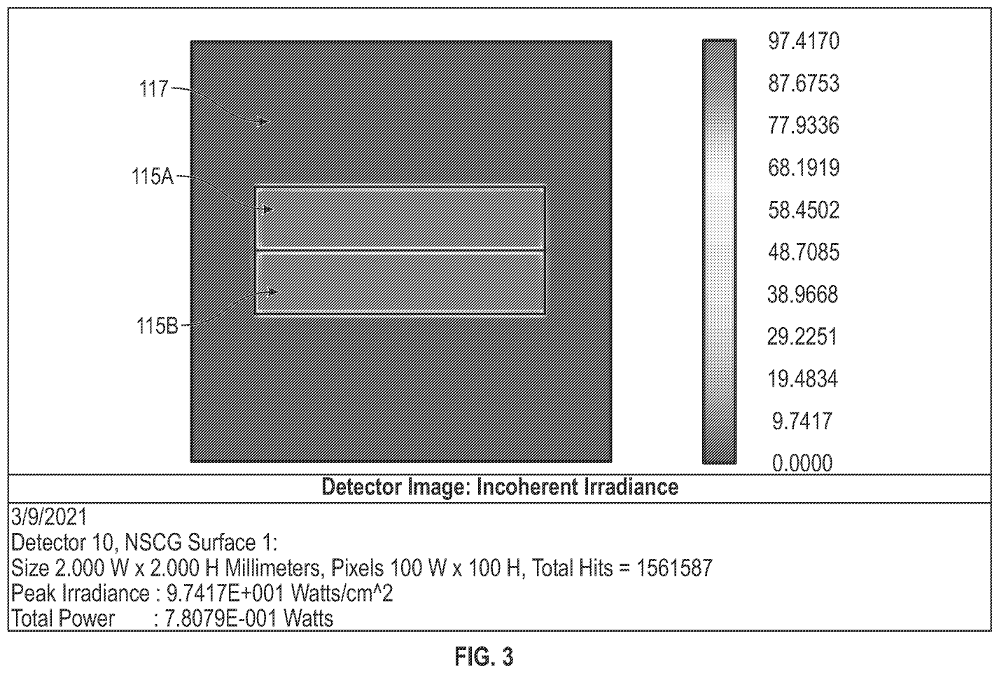

FIG. 3 is a far-field image illustrating the benefit of the example embodiment shown in FIG. 2. FIG. 3 illustrates the benefit of using the prism 110A and prism 110B (which, as discussed above, may be separate components or a single rooftop prism) along with the VCSEL array 100A and VCSEL array 100B in accordance with some embodiments. FIG. 3 shows the far field image for the configuration shown in FIG. 2 (i.e., with refractive rooftop prisms in place). The effect of the prism 110A and prism 110B is to effectively remove the large gap 113 between the VCSEL array 100A and VCSEL array 100B, making them appear to the imaging lens as a single larger optical array 100.

In some embodiments, depending on the amount of ray bending and minimum feature size specified by a manufacturer of diffractive optical elements, a diffractive surface can replace a refractive surface. For example, replacing the angled surfaces of the prism 110A and prism 110B in FIG. 2 with diffractive surfaces would allow the micro-optic to be fabricated on a flat surface.

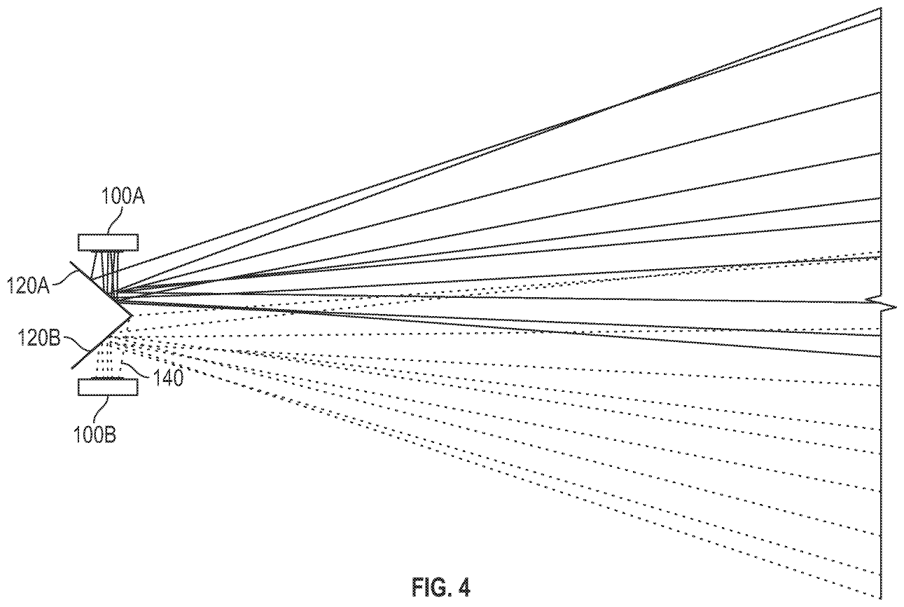

In some embodiments, mirrors can be used with optical arrays that are situated in different planes and are therefore separated from each other. FIG. 4 illustrates an example configuration with two optical arrays and two mirrors in accordance with some embodiments. Once again, the example shows the VCSEL array 100A and VCSEL array 100B, but it is to be appreciated that the techniques are suitable for use with other types of optical arrays. As illustrated, the VCSEL array 100A and the VCSEL array 100B are situated in different planes, and they face each other. Specifically, the VCSEL array 100A is situated in an upper plane, and the VCSEL array 100B is in a lower plane. The individual optical components 101 of the VCSEL array 100A and the individual optical components 101 of the VCSEL array 100B face each other. Two 45-degree mirrors, namely the mirror 120A and the mirror 120B, are situated between the VCSEL array 100A and the VCSEL array 100B. The configuration illustrated in FIG. 4 allows the VCSEL array 100A and the VCSEL array 100B to be spaced further apart from each other (thereby facilitating electrical connections to the VCSEL array 100A and the VCSEL array 100B). Thus, the example configuration of FIG. 4 can improve heat dissipation for the VCSEL array 100A and the VCSEL array 100B (e.g., if they are high-wattage arrays 100).

In the example embodiment shown in FIG. 4, the VCSEL array 100A and VCSEL array 100B have a divergence of about 30 degrees, and some of the rays may miss their respective mirror (e.g., rays from the VCSEL array 100A may miss the mirror 120A and/or rays from the VCSEL array 100B may miss the mirror 120B) and are not reflected. FIG. 4 shows a ray 140 from the VCSEL array 100B that almost misses the mirror 120B, but it hits the mirror 120B near the vertex between the mirror 120A and the mirror 120B and is reflected.

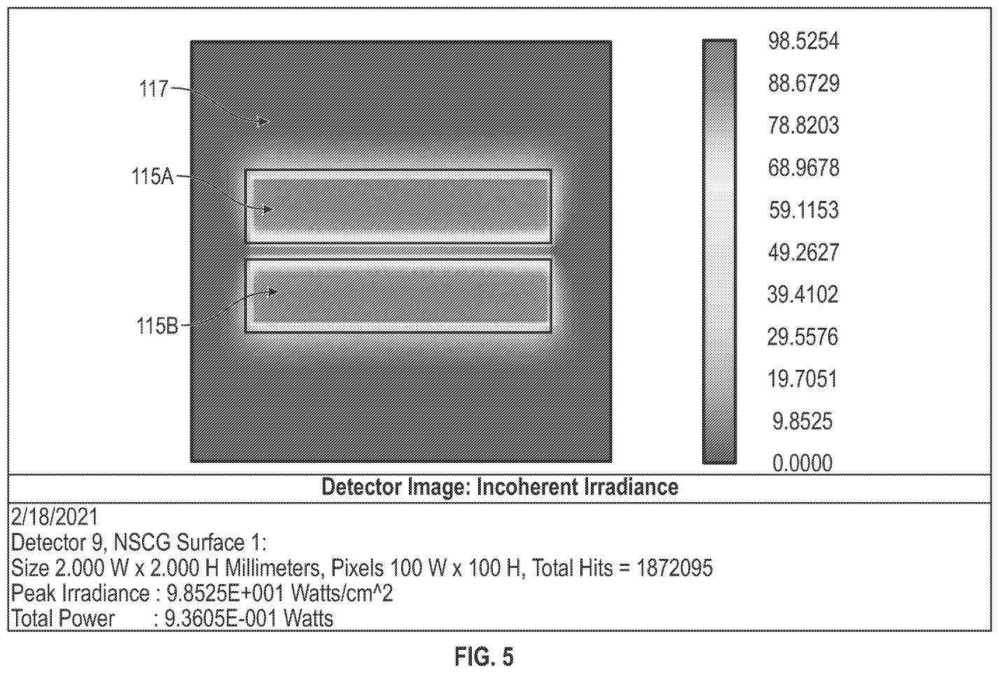

FIG. 5 is a far-field image illustrating the benefit of the example embodiment shown in FIG. 4. FIG. 5 shows an example far-field image of the VCSEL array 100A and the VCSEL array 100B when situated with the mirror 120A and the mirror 120B as shown in FIG. 4. Generally speaking, the image shown in FIG. 5 is fuzzier than the image shown in FIG. 3 (with the prism 110A and prism 110B shown in FIG. 2) due to the rays in the configuration of FIG. 4 propagating in air before hitting the mirror 120A or mirror 120B and being reflected toward the imaging lens (not shown). “Stray” rays such as the ray 140 in FIG. 4 are responsible for the fuzziness in the example image of FIG. 5.

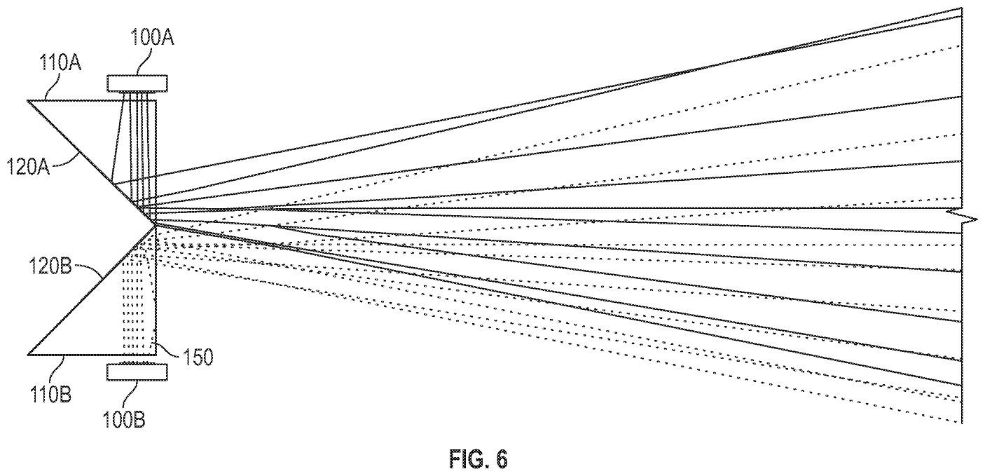

In some embodiments, the advantages of a refractive element (e.g., as shown in FIG. 2) are combined with a 45-degree mirror configuration (e.g., as shown in FIG. 4), using two prisms and two mirrors to reflect the light. FIG. 6 illustrates an example configuration with two optical arrays, two prisms, and two mirrors in accordance with some embodiments. As shown in FIG. 6, a prism 110A and a mirror 120A are situated in front of the VCSEL array 100A, and a prism 110B and a mirror 120B are situated in front of the VCSEL array 100B. The prism 110A and mirror 120A may be separate physical components, or they may be part of an integrated component (e.g., they may be inseparable). Similarly, the prism 110B and mirror 120B may be separate or integrated physical components. Likewise, some or all of the prism 110A, mirror 120A, prism 110B, and/or mirror 120B can be integrated into a single physical component.

As FIG. 6 illustrates, because the rays from the VCSEL array 100A and the rays from the VCSEL array 100B traveling substantially in glass (rather than air) before hitting a reflective surface (e.g., the mirror 120A or mirror 120B), the ray bundles stay more compact, and the rays do not diverge as much at a selected distance as they do in FIG. 4 at that same selected distance. Furthermore, as can be seen by the ray 150 from the mirror 120B in FIG. 6, total internal reflection off the front face of the prism 110B (or, for rays from the VCSEL array 100A, the prism 110A) redirects these stray rays back toward their respective mirror (i.e., the ray 150 is redirected back toward the mirror 120B). After reflection by the mirror 120A or mirror 120B, the rays exit through the front face of their respective prism (prism 110A for rays off of mirror 120A and prism 110B for rays off of mirror 120B) toward the imaging lens (not shown). As a result, a higher total power is reflected out.

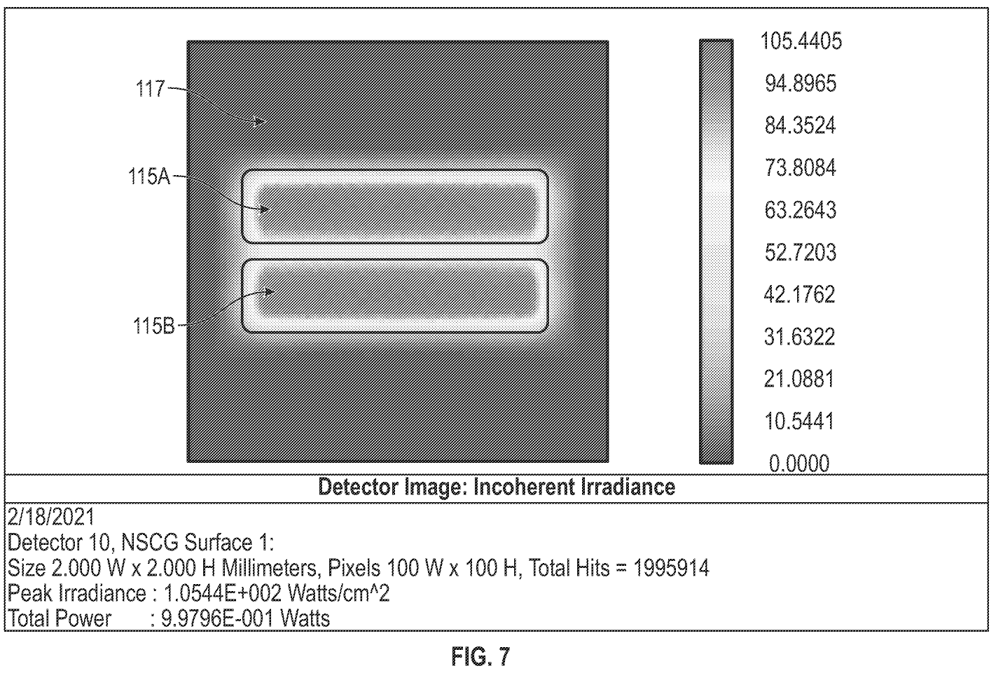

FIG. 7 is a far-field image illustrating the benefit of the example embodiment shown in FIG. 6. FIG. 7 shows an example far-field image of the VCSEL array 100A and the VCSEL array 100B when situated with the prism 110A, the mirror 120A, the prism 110B, and the mirror 120B as shown in FIG. 6. FIG. 7 shows that nearly 100% of the power of the VCSEL array 100A and the VCSEL array 100B is put into the far field image.

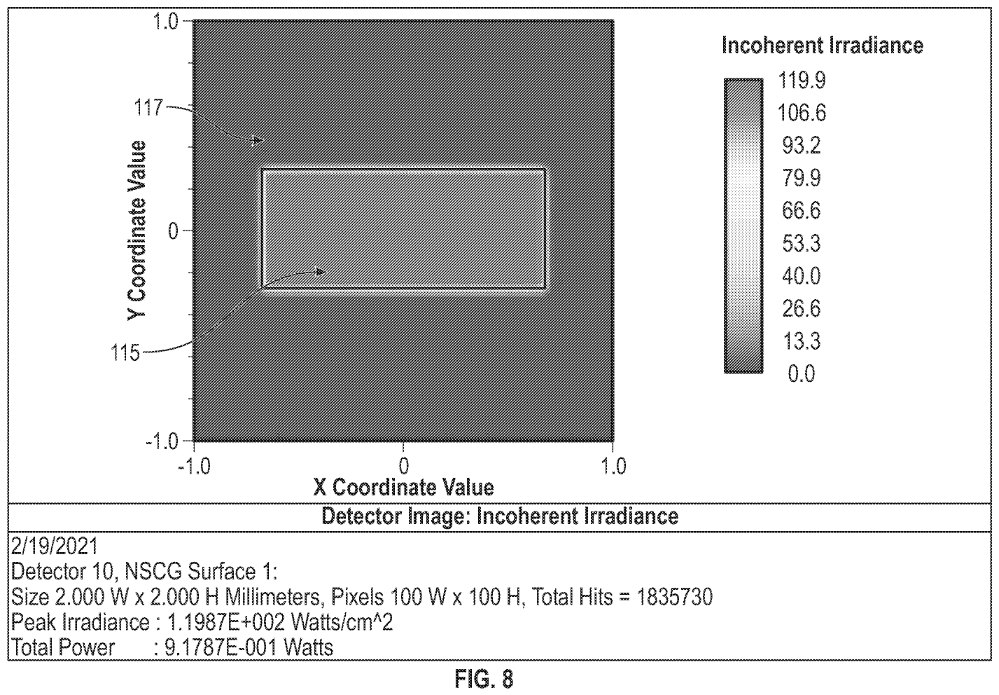

Because the rays emitted by the VCSEL array 100A and VCSEL array 100B travel mostly through glass before exiting the prism 110A or the prism 110B, the VCSEL array 100A and VCSEL array 100B can be moved very close to the front faces of, respectively, the prism 110A and the prism 110B without a significant loss of power. FIG. 8 is a far-field image illustrating the benefit of such a modification of the example embodiment shown in FIG. 6. FIG. 8 shows an example far-field image of the VCSEL array 100A and the VCSEL array 100B when the VCSEL array 100A is situated closer to the prism 110A and the VCSEL array 100B is situated closer to the prism 110B than in the configuration used to generate FIG. 7. Moving the VCSEL array 100A and the VCSEL array 100B closer to their respective prisms improves the uniformity of the far field image, as shown in FIG. 8. The region 115A and region 115B merge into a single region 115. Although there may be slightly more energy loss with this approach (e.g., approximately 8% in some exemplary embodiments), the use of prism 110A and prism 110B allows this flexibility.

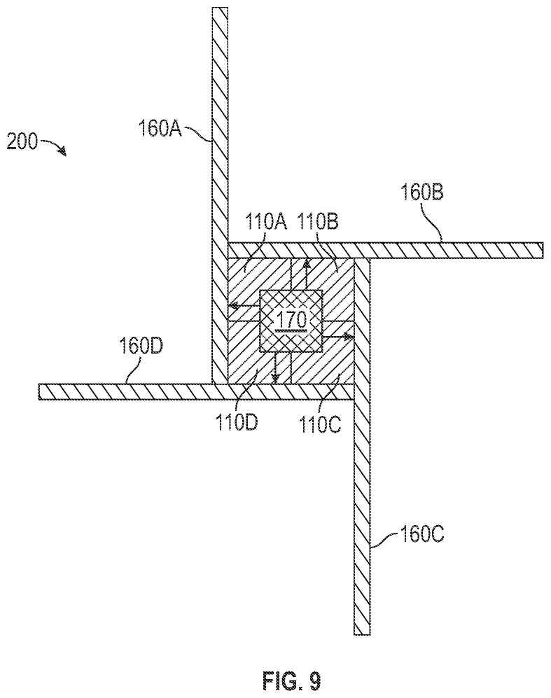

The example configurations described above include two optical arrays, but it is to be appreciated that more than two arrays can be optically combined using the techniques described herein. FIG. 9 is an end-on view of an example system 200 in accordance with some embodiments. As shown in FIG. 9, the system 200 produces a virtual array image 170, as seen by a collimator lens. The example system 200 includes four arrays (e.g., VCSEL arrays, detector arrays, etc.), which are situated with a respective four prisms, namely prism 110A, prism 110B, prism 110C, and prism 110D. The prism 110A, prism 110B, prism 110C, and prism 110D may be, for example, as described above in the discussion of FIG. 2. In the configuration of FIG. 9, the 45-degree sloped faces of the prism 110A, prism 110B, prism 110C, and prism 110D are in four different directions so that each reflects a virtual image to or from a respective optical array situated on a respective PCB. In the example of FIG. 9, a first optical array is situated on the PCB 160A, a second optical array is situated on the PCB 160B, a third optical array is situated on the PCB 160C, and a fourth optical array is situated on the PCB 160D. (The view shows the edges of the PCBs.) The optical arrays of FIG. 9 are not visible because they are blocked in the illustrated view by the prism 110A, prism 110B, prism 110C, and prism 110D. The PCB 160A and the PCB 160C are substantially parallel to each other and substantially perpendicular to the PCB 160B and the PCB 160D. The arrows indicate which optical array/prism combination produces each quadrant of the virtual array image 170. As shown in FIG. 9, there is no gap in the virtual array image 170, which is a combination of the four images corresponding to the four optical arrays.

It is to be understood that the prism 110A, prism 110B, prism 110C, and prism 110D shown in FIG. 9 can be any suitable optical components. For example, as described above in the discussions of FIGS. 2-8, virtual images can be combined using refractive, reflective, or diffractive components, or using a combination of refractive, reflective, and/or diffractive optical elements.

It is to be understood that although certain examples are provided herein of components that are suitable to implement the disclosed devices, systems, and methods, other components can also be used. As a specific example, the faces of a rooftop prism are not required to meet at 90 degrees, and generally do not meet at 90 degrees for a purely refractive solution. For example, in the exemplary embodiment of FIG. 6, with reflective prisms, the structure looks like the negative rooftop prism in many ways, but the faces are reflective rather than refractive as in the embodiment illustrated in FIG. 2. It is to be appreciated the combination of prisms or prismatic faces can be achieved using other types of prisms. As will be understood in light of the disclosures herein, the objective is to use a multiplicity of sloped flat faces, rather than curved faces as on a lens, so that the lens “sees” an undistorted virtual image of the optical array, except that it appears to be in a different location. Armed with the disclosures herein, those having ordinary skill in the art will be able to select suitable components to achieve the benefits described.

It is also to be appreciated that one could distort a rectangular array 100 (e.g., a VCSEL array) into a square shape using a negative cylindrical lens, but this approach would reduce intensity in the overall beam, which may be undesirable. In contrast, the techniques disclosed herein of optically combining arrays 100 allow the amount of wattage under a single lens to be doubled while keeping high beam intensity. In some embodiments, using a number of transmissive (refractive) faces, or a number of prisms, that is generally equal to the number of arrays 100 to be combined allows the images to be shifted so that the multiple arrays 100 appear to be one larger monolithic array 100.

Although most of the examples provided herein show two arrays 100 (the VCSEL array 100A and VCSEL array 100B), it is to be appreciated that, as explained in the discussion of FIG. 9 above, the techniques can be used to combine more than two arrays 100, and different types of array 100 (e.g., detector arrays, etc.). For example, as shown and described in the context of FIG. 9, four arrays 100 can be combined using the same techniques. More than four arrays 100 can also be combined, potentially with additional techniques such as, for example, multiplexing by wavelength using, e.g., dichroic mirrors.

It is also to be appreciated that, as explained above, the use of VCSEL arrays as examples is not to be interpreted as limiting the disclosures to VCSEL arrays. As stated above, the same principles can be applied to other types of emitters, and to detector arrays.

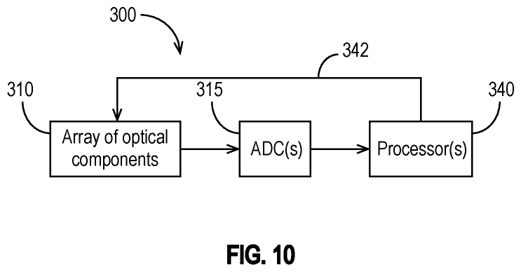

FIG. 10 illustrates certain components of an example LiDAR system 300 in accordance with some embodiments. The LiDAR system 300 includes an array of optical components 310 coupled to at least one processor 340. The array of optical components 310 may be in the same physical housing (or enclosure) as the at least one processor 340, or it may be physically separate.

The array of optical components 310 includes a plurality of illuminators (e.g., lasers, VCSELs, etc.) and a plurality of detectors (e.g., photodiodes, APDs, etc.), some or all of which may be included in separate physical arrays (e.g., emitter and/or detector arrays 100 as described above). The array of optical components 310 may include any of the embodiments described herein (e.g., individual arrays 100 in conjunction with one or more of prism 110A, prism 110B, mirror 120A, mirror 120B, etc.), which may remove gaps or dead spaces from a FOV.

The at least one processor 340 may be, for example, a digital signal processor, a microprocessor, a controller, an application-specific integrated circuit, or any other suitable hardware component (which may be suitable to process analog and/or digital signals). The at least one processor 340 may provide control signals 342 to the array of optical components 310. The control signals 342 may, for example, cause one or more emitters in the array of optical components 310 to emit optical signals (e.g., light) sequentially or simultaneously.

The LiDAR system 300 may optionally also include one or more analog-to-digital converters (ADCs) 315 disposed between the array of optical components 310 and the at least one processor 340. If present, the one or more ADCs 315 convert analog signals provided by detectors in the array of optical components 310 to digital format for processing by the at least one processor 340. The analog signal provided by each of the detectors may be a superposition of reflected optical signals detected by that detector, which the at least one processor 340 may then process to determine the positions of targets corresponding to (causing) the reflected optical signals.

In the foregoing description and in the accompanying drawings, specific terminology has been set forth to provide a thorough understanding of the disclosed embodiments. In some instances, the terminology or drawings may imply specific details that are not required to practice the invention.

To avoid obscuring the present disclosure unnecessarily, well-known components are shown in block diagram form and/or are not discussed in detail or, in some cases, at all.

Unless otherwise specifically defined herein, all terms are to be given their broadest possible interpretation, including meanings implied from the specification and drawings and meanings understood by those skilled in the art and/or as defined in dictionaries, treatises, etc. As set forth explicitly herein, some terms may not comport with their ordinary or customary meanings.

As used herein, the singular forms “a,” “an” and “the” do not exclude plural referents unless otherwise specified. The word “or” is to be interpreted as inclusive unless otherwise specified. Thus, the phrase “A or B” is to be interpreted as meaning all of the following: “both A and B,” “A but not B,” and “B but not A.” Any use of “and/or” herein does not mean that the word “or” alone connotes exclusivity.

As used herein, phrases of the form “at least one of A, B, and C,” “at least one of A, B, or C,” “one or more of A, B, or C,” and “one or more of A, B, and C” are interchangeable, and each encompasses all of the following meanings: “A only,” “B only,” “C only,” “A and B but not C,” “A and C but not B,” “B and C but not A,” and “all of A, B, and C.”

To the extent that the terms “include(s),” “having,” “has,” “with,” and variants thereof are used herein, such terms are intended to be inclusive in a manner similar to the term “comprising,” i.e., meaning “including but not limited to.”

The terms “exemplary” and “embodiment” are used to express examples, not preferences or requirements.

The term “coupled” is used herein to express a direct connection/attachment as well as a connection/attachment through one or more intervening elements or structures.

The term “plurality” is used herein to mean “two or more.”

The terms “over,” “under,” “between,” and “on” are used herein refer to a relative position of one feature with respect to other features. For example, one feature disposed “over” or “under” another feature may be directly in contact with the other feature or may have intervening material. Moreover, one feature disposed “between” two features may be directly in contact with the two features or may have one or more intervening features or materials. In contrast, a first feature “on” a second feature is in contact with that second feature.

The term “substantially” is used to describe a structure, configuration, dimension, etc. that is largely or nearly as stated, but, due to manufacturing tolerances and the like, may in practice result in a situation in which the structure, configuration, dimension, etc. is not always or necessarily precisely as stated. For example, describing two lengths as “substantially equal” means that the two lengths are the same for all practical purposes, but they may not (and need not) be precisely equal at sufficiently small scales. As another example, a first structure that is “substantially perpendicular” to a second structure would be considered to be perpendicular for all practical purposes, even if the angle between the two structures is not precisely 90 degrees.

The drawings are not necessarily to scale, and the dimensions, shapes, and sizes of the features may differ substantially from how they are depicted in the drawings.

Although specific embodiments have been disclosed, it will be evident that various modifications and changes may be made thereto without departing from the broader spirit and scope of the disclosure. For example, features or aspects of any of the embodiments may be applied, at least where practicable, in combination with any other of the embodiments or in place of counterpart features or aspects thereof. Accordingly, the specification and drawings are to be regarded in an illustrative rather than a restrictive sense.

1. A system, comprising:
a first optical array comprising a first active area;
a second optical array comprising a second active area, wherein the first active area and the second active area are separated by a distance; and
at least one optical component configured to laterally-shift a virtual image corresponding to at least one of the first optical array or the second optical array, thereby reducing a gap in a field of view of the system.

2. The system recited in claim 1, wherein the first optical array is situated in a first die, and the second optical array is situated in a second die, and wherein the first die is in contact with the second die.

3. The system recited in claim 1, further comprising a imaging lens, and wherein the at least one optical component is situated between the first and second optical arrays and the imaging lens.

4. The system recited in claim 1, wherein the first optical array comprises a first plurality of emitters, and the second optical array comprises a second plurality of emitters.

5. The system recited in claim 4, wherein the first plurality of emitters and the second plurality of emitters comprise a plurality of lasers.

6. The system recited in claim 5, wherein at least one of the plurality of lasers comprises a vertical cavity surface emitting laser (VCSEL).

7. (canceled)

8. The system recited in claim 1, wherein the first optical array comprises a first plurality of detectors, and the second optical array comprises a second plurality of detectors.

9. The system recited in claim 8, wherein the first plurality of detectors and the second plurality of detectors comprise a plurality of photodiodes.

10. The system recited in claim 9, wherein at least one of the plurality of photodiodes comprises an avalanche photodiode (APD).

11. (canceled)

12. The system recited in claim 1, wherein the at least one optical component comprises at least one of a prism or a mirror.

13. The system recited in claim 1, wherein the at least one optical component comprises at least one of (a) a negative rooftop glass prism situated over the first optical array and the second optical array, or (b) a diffractive surface.

14. (canceled)

15. The system recited in claim 1, wherein the at least one optical component comprises first and second mirrors.

16. The system recited in claim 15, wherein the first and second mirrors are 45-degree mirrors situated between the first optical array and the second optical array, and wherein the first optical array and the second optical array are situated in different planes.

17. The system recited in claim 16, wherein the first active area faces the second active area.

18. The system recited in claim 1, wherein the at least one optical component comprises:
first and second mirrors in a 45-degree configuration; and
first and second prisms situated between the first and second mirrors.

19. The system recited in claim 1, further comprising:
a third optical array comprising a third active area; and
a fourth optical array comprising a fourth active area,
and wherein:
the first optical array is situated on a first printed circuit board (PCB),
the second optical array is situated on a second PCB, the second PCB being substantially perpendicular to the first PCB,
the third optical array is situated on a third PCB, the third PCB being substantially parallel to the first PCB and substantially perpendicular to the second PCB,
the fourth optical array is situated on a fourth PCB, the fourth PCB being substantially parallel to the second PCB and substantially perpendicular to the first PCB and to the third PCB, and
the at least one optical component comprises a first prism situated over the first active area, a second prism situated over the second active area, a third prism situated over the third active area, and a fourth prism situated over the fourth active area.

20. The system recited in claim 19, wherein the first prism, the second prism, the third prism, and the fourth prism are in contact.

21. The system recited in claim 19, wherein the first active area faces the third active area, and the second active area faces the fourth active area.

22. The system recited in claim 19, wherein the first optical array comprises a first plurality of emitters, the second optical array comprises a second plurality of emitters, the third optical array comprises a third plurality of emitters, and the fourth optical array comprises a fourth plurality of emitters.

23. The system recited in claim 22, wherein the first plurality of emitters, the second plurality of emitters, the third plurality of emitters, and the fourth plurality of emitters comprise a plurality of lasers.

24. The system recited in claim 23, wherein at least one of the plurality of lasers comprises vertical cavity surface emitting laser (VCSEL).

25. (canceled)

26. The system recited in claim 19, wherein the first optical array comprises a first plurality of detectors, the second optical array comprises a second plurality of detectors, the third optical array comprises a third plurality of detectors, and the fourth optical array comprises a fourth plurality of detectors.

27. The system recited in claim 26, wherein the first plurality of detectors, the second plurality of detectors, the third plurality of detectors, and the fourth plurality of detectors comprise a plurality of photodiodes.

28. The system recited in claim 27, wherein at least one of the plurality of photodiodes comprises an avalanche photodiode (APD).

29. (canceled)
